(19) United States
(12) Patent Application Publication
(10) Pub. No.: US 2023/0079174 A1
(43) Pub. Date: Mar. 16, 2023

(54) WIRED COMPOSITE PROCESS MOBILE PHONE CASE AND MANUFACTURING METHOD THEREOF

(71) Applicant: SHENZHEN RUNJIANGNAN TECHNOLOGY CO., LTD, SHENZHEN (CN)

(72) Inventor: RUNJIANG OU, PINGXIANG (CN)

(21) Appl. No.: 17/489,818

(22) Filed: Sep. 30, 2021

(30) Foreign Application Priority Data
Sep. 14, 2021 (CN) 2021108192480

(51) Int. Cl. B29D 99/00; A45C 11/00

(52) U.S. Cl. CPC B29D 99/006; A45C 11/00; A45C 2011/002; B29C 2793/0081; B29K 2633/12

(57) ABSTRACT

The present disclosure provides a wired composite process mobile phone case manufacturing method, including following steps: A. cutting raw material sheets according to a preset size, and cleaning and drying the raw material sheets; B. positioning the raw material sheets on a curing device, coating optical Ultraviolet Rays (UV) glue on the raw material sheets, placing wired materials on surfaces of the raw material sheets coated with the optical UV glue, then coating the optical UV glue on surfaces of the wired materials, and laying the raw material sheets on the surfaces of the wired materials; C. curing the optical UV glue to obtain a semi-finished product of a mobile phone case; and D. injection molding the semi-finished product of the mobile phone case to obtain a finished product of the mobile phone case.

### TECHNICAL FIELD

The present disclosure relates to a technical field of mobile phone case manufacturing, and in particular to a wired composite process mobile phone case and a manufacturing method thereof.

### BACKGROUND

In order to protect mobile phones from being damaged, each of the present mobile phones is usually equipped with a mobile phone case. The mobile phone cases are diversified with increase of functions of the mobile phones and handheld electronic products. The mobile phone cases on present market are generally a polycarbonate (PC) case, a thermoplastic polyurethanes (TPU) mobile phone case, an in molding label (IML) process mobile phone case, a glue dripping process mobile phone case, etc., surface hardness of the mobile phone cases is 1-2H, the mobile phone cases are easy to be scratched, and attractiveness of the mobile phone cases may be seriously affected.

### SUMMARY

A technical problem to be solved by the present disclosure is to provide a wired composite process mobile phone case and a manufacturing method thereof, which can solve shortcomings of the present technology, hardness of the wired composite process mobile phone case can reach 6-9H, and durability of which is good

In order to solve the above technical problem, a technical solution adopted by the present disclosure is as follows.

The present disclosure provides a wired composite process mobile phone case manufacturing method, including following steps:

A. cutting raw material sheets according to a preset size, and cleaning and drying the raw material sheets.

B. positioning the raw material sheets on a curing device, coating optical Ultraviolet Rays (UV) glue on the raw material sheets, placing wired materials on surfaces of the raw material sheets coated with the optical UV glue, then coating the optical UV glue on surfaces of the wired materials, and laying the raw material sheets on the surfaces of the wired materials.

C. curing the optical UV glue to obtain a semi-finished product of a mobile phone case.

D. injection molding the semi-finished product of the mobile phone case to obtain a finished product of the mobile phone case.

Optionally, the raw material sheets are Polymethylmethacrylate (PMMA), Polycarbonate (PC), or Polyethylene terephthalate (PET).

Optionally, the curing device includes a base, a plurality of clamps configured to fix the raw material sheets are disposed on the base, a track is disposed on two sides of the base, a bracket is disposed on the track, and a bottom of the bracket is connected with driving wheels through at least one motor. The driving wheels roll on the track, a gluing roller is disposed on the bracket through a first oil cylinder, a platform is disposed on the bracket through a second oil cylinder, a first UV light is disposed in a middle of the platform, two pressing rollers are disposed on two sides of the platform, and a second UV light is disposed below the base.

Optionally, a scraping plate is fixed on an outer side of the gluing roller, the scraping plate is in contact with a surface of the gluing roller, a plurality of discharging openings are disposed on one side, facing the gluing roller, of the scraping plate, and the optical UV glue flows out of the plurality of the discharging openings and then is coated on the surface of the gluing roller through the scraping plate.

Optionally, a material groove is disposed below each of the plurality of the discharging openings, a side wall of the material groove is an arc matched with the gluing roller, and a rotating direction of the gluing roller is from a bottom of the scraping plate towards a top of the scraping plate.

Optionally, swing motors are disposed on the platform, a respective air cylinder is disposed on a driving end of each of the swing motors, and a piston end of the respective air cylinder is connected with a respective one of the two pressing rollers through a perspective spring.

Optionally, in the step C, when starting curing, turning on the first UV light and the second UV light, lowering the first UV light to a preset position through the second oil cylinder, then moving the two pressing rollers to separate to a maximum distance, and pressing the two pressing rollers on surfaces of the raw material sheets through the respective air cylinder; setting an initial pressure of the two pressing rollers as fifty percent of a preset rated pressure, along with an increase of curing time, the swing motors gradually reduce a distance between the two pressing rollers while the respective air cylinder gradually increases down force of the respective one of the two pressing rollers, at one minute before an end of the curing, moving the two pressing rollers to separate to a minimum distance, and the down force of the respective one of the two pressing rollers reaches the preset rated pressure.

The present disclosure further provides a wired composite process mobile phone case, and the wired composite process mobile phone case is made by using the wired composite process mobile phone case manufacturing method provided above.

Beneficial effects brought by the above technical solution are as follows.

The present disclosure optimizes a curing process of the wired materials to successfully manufacture the wired composite process mobile phone case, the hardness can be 6-9H, which is not easy to be scratched, and different requirements of consumers can be met by selecting different wired materials. The present disclosure further optimizes a coating structure, and coating uniformity of the optical UV glue is improved through scraping the surfaces of the gluing roller with the scraping plate. In the curing process, the pressing rollers are configured to circulate downward pressing, and meanwhile, a downward pressing angle and the down force are optimized, so that curing uniformity of the optical UV glue is improved, and the durability of the mobile phone case is further greatly improved.

### BRIEF DESCRIPTION OF DRAWINGS

FIG. 1 is a structural schematic diagram of a curing device according to one embodiment of the present disclosure.

FIG. 2 is a structural schematic diagram of a scraping plate according to one embodiment of the present disclosure.

In the drawings: 1. base; 2. clamp; 3. track; 4. bracket; 5. motor; 6. driving wheel; 7. first oil cylinder; 8. gluing roller; 9. second oil cylinder; 10. platform; 11. first UV light; 12. pressing roller; 13. second UV light; 14. scraping plate; 15. discharging opening; 16. material groove; 17. slit; 18. swing motor; 19. air cylinder; and 20. spring.

### DETAILED DESCRIPTION

One embodiment of the present disclosure includes following steps.

A. cutting PMMA raw material sheets according to a preset size, and cleaning and drying the PMMA raw material sheets.

B. positioning the PMMA raw material sheets on a curing device, coating optical UV glue on the PMMA raw material sheets, placing wired materials on surfaces of the PMMA raw material sheets coated with the optical UV glue, then coating the optical UV glue on surfaces of the wired materials, and laying the PMMA raw material sheets on the surfaces of the wired materials.

C. curing the optical UV glue to obtain a semi-finished product of a mobile phone case.

D. injection molding the semi-finished product of the mobile phone case to obtain a finished product of the mobile phone case.

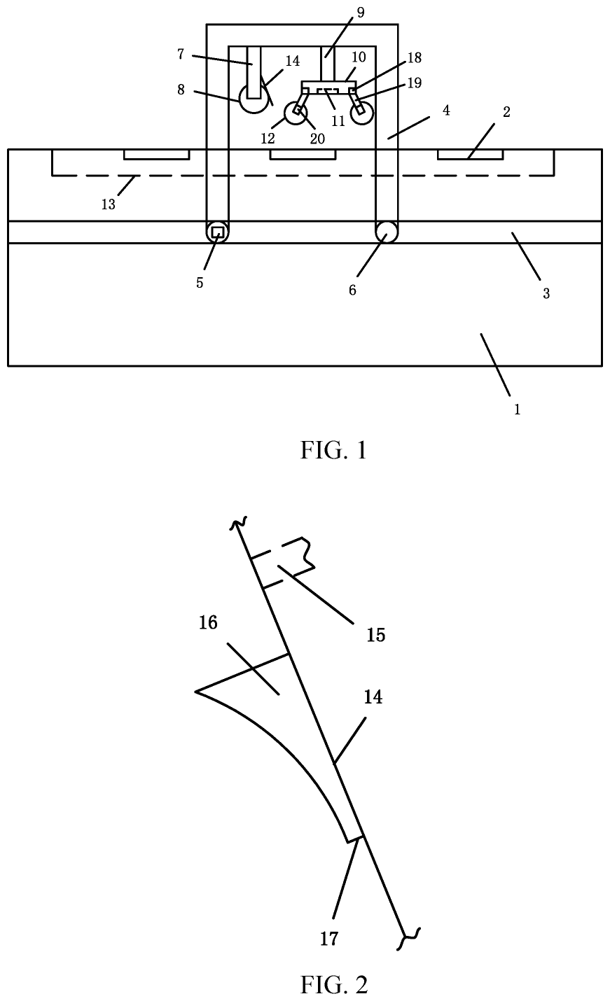

Referring to FIGS. 1-2, the curing device includes a base 1, a plurality of clamps 2 configured to fix PMMA raw material sheets are disposed on the base 1, a track 3 is disposed on two sides of the base 1, a bracket 4 is disposed on the track 3, and a bottom of the bracket 4 is connected with driving wheels 6 through at least one motor 5. The driving wheels 6 roll on the track 3, a gluing roller 8 is disposed on the bracket 4 through a first oil cylinder 7, a platform 10 is disposed on the bracket 4 through a second oil cylinder 9, a first UV light 1 is disposed in a middle of the platform 10, two pressing rollers 12 are disposed on two sides of the platform 10, and a second UV light 13 is disposed below the base 1. A scraping plate 14 is fixed on an outer side of the gluing roller 8, the scraping plate 14 is in contact with a surface of the gluing roller 8, a plurality of discharging openings 15 are disposed on one side, facing the gluing roller 8, of the scraping plate 14, and the optical UV glue flows out the plurality of the discharging openings 15 and then is coated on the surface of the gluing roller 8 through the scraping plate 14. A material groove 16 is disposed below each of the plurality of the discharging openings 15, a side wall of the material groove 16 is an arc matched with the gluing roller 8, a slit 17 configured to discharge the wired materials is disposed on a bottom of the material groove 16, and a rotating direction of the gluing roller 8 is from a bottom of the scraping plate 14 towards a top of the scraping plate 14. Swing motors 18 are disposed on the platform 10, a respective air cylinder 19 is disposed on a driving end of each of the swing motors 18, and a piston end of the respective air cylinder 19 is connected with a respective one of the two pressing rollers 12 through a perspective spring 20.

Furthermore, in the step C, when starting curing, turning on the first UV light 11 and the second UV light 13, lowering the first UV light 1 to a preset position through the second oil cylinder 9, then moving the two pressing rollers 12 to separate to a maximum distance, and pressing the two pressing rollers 12 on surfaces of the PMMA raw material sheets through the respective air cylinder 19; setting an initial pressure of the two pressing rollers 12 as fifty percent of a preset rated pressure, along with an increase of curing time, the swing motors 18 gradually reduce a distance between the two pressing rollers 12 while the perspective air cylinder 19 gradually increases down force of the respective one of the two pressing rollers 12, at one minute before an end of the curing, moving the two pressing rollers 12 to separate to a minimum distance, and the down force of the respective one of the two pressing rollers 12 reaches the preset rated pressure.

The swing motors 18 change the distance between the two pressing rollers 12 at a constant speed through adjusting a rotating speed, and meanwhile, the respective air cylinder 19 is matched with a rotation of the swing motors 18, so that a down force change rate of the pressing rollers 12 is directly proportional to a square of the curing time until the preset rated pressure is reached. Through the above optimization control process, local deformation of the optical UV glue caused by excessive pressure at an early stage of curing can be avoided, and meanwhile, insufficient strength of the internal curing structure of the optical UV glue caused by insufficient pressure at a late stage of curing is avoided

In the description of the present disclosure, it is to be understood that the terms “longitudinal”, “transverse”, “upper”, “lower”, “front”, “rear”, “left”, “right”, “vertical”, “horizontal”, “top”, “bottom”, “inner”, “outer”, etc., are merely intended to facilitate the description of the present disclosure, rather than indicating or implying that an indicated device or element must have a particular orientation, is constructed and operated in a particular orientation, and is therefore not to be construed as a limitation of the present disclosure.

The above shows and describes basic principles and main features of the present disclosure and advantages of the present disclosure. It should be understood by those who skilled in the art that the present disclosure is not limited by the foregoing embodiments, and the foregoing embodiments and the description are merely illustrative of the principles of the present disclosure, and various changes and modifications may be made to the present disclosure without departing from spirits and scopes of the present disclosure, and these variations and improvements fall within scopes of the present disclosure as claimed. The scopes of the present disclosure are defined by the appended claims and their equivalents.

What is claimed is:

1. A wired composite process mobile phone case manufacturing method, comprising:
A. cutting raw material sheets according to a preset size, and cleaning and drying the raw material sheets;
B. positioning the raw material sheets on a curing device, coating optical Ultraviolet Rays (UV) glue on the raw material sheets, placing wired materials on surfaces of the raw material sheets coated with the optical UV glue, then coating the optical UV glue on surfaces of the wired materials, and laying the raw material sheets on the surfaces of the wired materials;
C. curing the optical UV glue to obtain a semi-finished product of a mobile phone case; and
D. injection molding the semi-finished product of the mobile phone case to obtain a finished product of the mobile phone case.

2. The wired composite process mobile phone case manufacturing method according to claim 1, wherein the raw material sheets are Polymethylmethacrylate (PMMA), Polycarbonate (PC), or Polyethylene terephthalate (PET).

3. The wired composite process mobile phone case manufacturing method according to claim 1, wherein the curing device comprises a base (1), a plurality of clamps (2) configured to fix the raw material sheets are disposed on the base (1), a track (3) is disposed on two sides of the base (1), a bracket (4) is disposed on the track (3), and a bottom of the bracket (4) is connected with driving wheels (6) through at least one motor (5); the driving wheels (6) roll on the track (3), a gluing roller (8) is disposed on the bracket (4) through a first oil cylinder (7), a platform (10) is disposed on the bracket (4) through a second oil cylinder (9), a first UV light (11) is disposed in a middle of the platform (10), two pressing rollers (12) are disposed on two sides of the platform (10), and a second UV light (13) is disposed below the base (1).

4. The wired composite process mobile phone case manufacturing method according to claim 3, wherein a scraping plate (14) is fixed on an outer side of the gluing roller (8), the scraping plate (14) is in contact with a surface of the gluing roller (8), a plurality of discharging openings (15) are disposed on one side, facing the gluing roller (8), of the scraping plate (14), and the optical UV glue flows out of the plurality of the discharging openings (15) and then is coated on the surface of the gluing roller (8) through the scraping plate (14).

5. The wired composite process mobile phone case manufacturing method according to claim 4, wherein a material groove (16) is disposed below each of the plurality of the discharging openings (15), a side wall of the material groove (16) is an arc matched with the gluing roller (8), and a rotating direction of the gluing roller (8) is from a bottom of the scraping plate (14) towards a top of the scraping plate (14).

6. The wired composite process mobile phone case manufacturing method according to claim 1, wherein swing motors (18) are disposed on the platform (10), a respective air cylinder (19) is disposed on a driving end of each of the swing motors (18), and a piston end of the respective air cylinder (19) is connected with a respective one of the two pressing rollers through a perspective spring (20).

7. The wired composite process mobile phone case manufacturing method according to claim 6, wherein in the step C, when starting curing, turning on the first UV light (11) and the second UV light (13), lowering the first UV light (11) to a preset position through the second oil cylinder (9), then moving the two pressing rollers (12) to separate to a maximum distance, and pressing the two pressing rollers (12) on surfaces of the raw material sheets through the respective air cylinder; setting an initial pressure of the two pressing rollers (12) as fifty percent of a preset rated pressure, along with an increase of curing time, the swing motors (18) gradually reduce a distance between the two pressing rollers (12) while the respective air cylinder (19) gradually increases down force of the respective one of the two pressing rollers (12), at one minute before an end of the curing, moving the two pressing rollers (12) to separate to a minimum distance, and the down force of the respective one of the two pressing rollers (12) reaches the preset rated pressure.

8. A wired composite process mobile phone case, wherein the wired composite process mobile phone case is made by using the wired composite process mobile phone case manufacturing method according to claim 1.
